(19) United States
(12) Patent Application Publication
(10) Pub. No.: US 2007/0011897 A1
(43) Pub. Date: Jan. 18, 2007

(54) Ruler with inlay strip

(76) Inventors: Javier Verdura, Milford, CT (US); Peter Michaelian, Tappan, NY (US); Stuart David Farnworth, Westport, CT (US)

Correspondence Address: ALIX YALE & RISTAS LLP, 750 MAIN STREET, SUITE 1400, HARTFORD, CT, 06103, US

(21) Appl. No.: 11/363,001

(22) Filed: Feb. 27, 2006

Related U.S. Application Data
(63) Continuation-in-part of application No. 29/213,442, filed on Sep. 17, 2004, now abandoned.

(51) Int. Cl. B43L 7/00

(52) U.S. Cl. 33/484

(57) ABSTRACT

A ruler incorporates a central longitudinal reinforcement strip. The strip has an upper surface which simulates wood grain. A pair of bosses integral with the base are received by openings of the inlay strip.

### CROSS-REFERENCE TO RELATED APPLICATION

This application is a continuation-in-part of U.S. patent application Ser. No. 29/213,442 filed on Sep. 17, 2004.

### BACKGROUND OF THE INVENTION

This invention relates generally to rulers. More particularly, this invention relates to rulers, such as may be adapted for use by schoolchildren.

In conventional rulers to which the invention relates, an elongated molded member typically has an upper surface which tapers toward opposed edges with measurement scales affixed adjacent to the opposed edges on upper surface portions thereof. Because such conventional rulers are typically formed of plastic or other flexible materials, the rulers through use flex over time, and become warped to the extent that they may not engage a planar surface along the entire underside support portion. The rulers are also susceptible to breaking from extreme flexure.

### SUMMARY OF THE INVENTION

Briefly stated, the invention in a preferred form is a ruler which comprises an elongated base. The base has an upper surface, a lower support portion and a pair of transversely opposed edges. The base defines a longitudinally extending channel of substantially uniform width and uniform depth. A pair of transversely spaced measuring scales are each disposed adjacent an edge on the upper surface portion thereof. An elongated inlay strip is disposed in the channel and extends substantially the longitudinal extent thereof.

The base may include a pair of longitudinally spaced bosses which project upwardly into the channel. The elongated strip has a pair of openings which mate with the bosses for securement purposes. The strip may be attached to the channel by adhesive or other means. In some embodiments, a hang hole extends through the strip and the base adjacent an end location. The elongated strip has a simulated wood grain surface and presents a pleasing aesthetic appearance, as well as, in conjunction with the base and the bosses, provides a reinforcing function for the ruler.

An object of the invention is to provide a new and improved ruler having an efficient and low cost construction.

Another object of the invention is to provide a new and improved ruler having an enhanced rigidity which is resistant to warpage and bending.

A further object of the invention is to provide a new and improved ruler having an aesthetically pleasing strip of simulated wood which also provides a reinforcement function.

Other objects and advantages of the invention will become apparent from the specification and the drawings.

### BRIEF DESCRIPTION OF THE DRAWINGS

FIG. 1 is a perspective view of a ruler with an inlay strip in accordance with the present invention;

FIG. 2 is a top plan view of the ruler of FIG. 1;

FIG. 3 is a bottom plan view of the ruler of FIG. 1;

FIG. 4 is a longitudinal edge view of the ruler of FIG. 1;

FIG. 5 is an end view of the ruler of FIG. 1; and

FIG. 6 is a sectional view taken along the line 6-6 of FIG. 2.

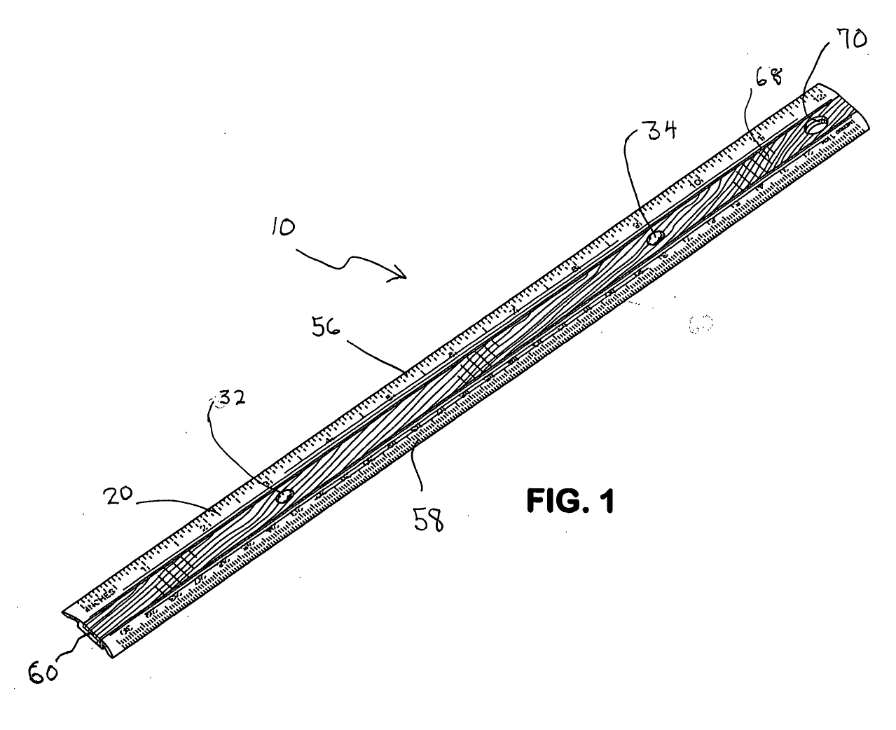

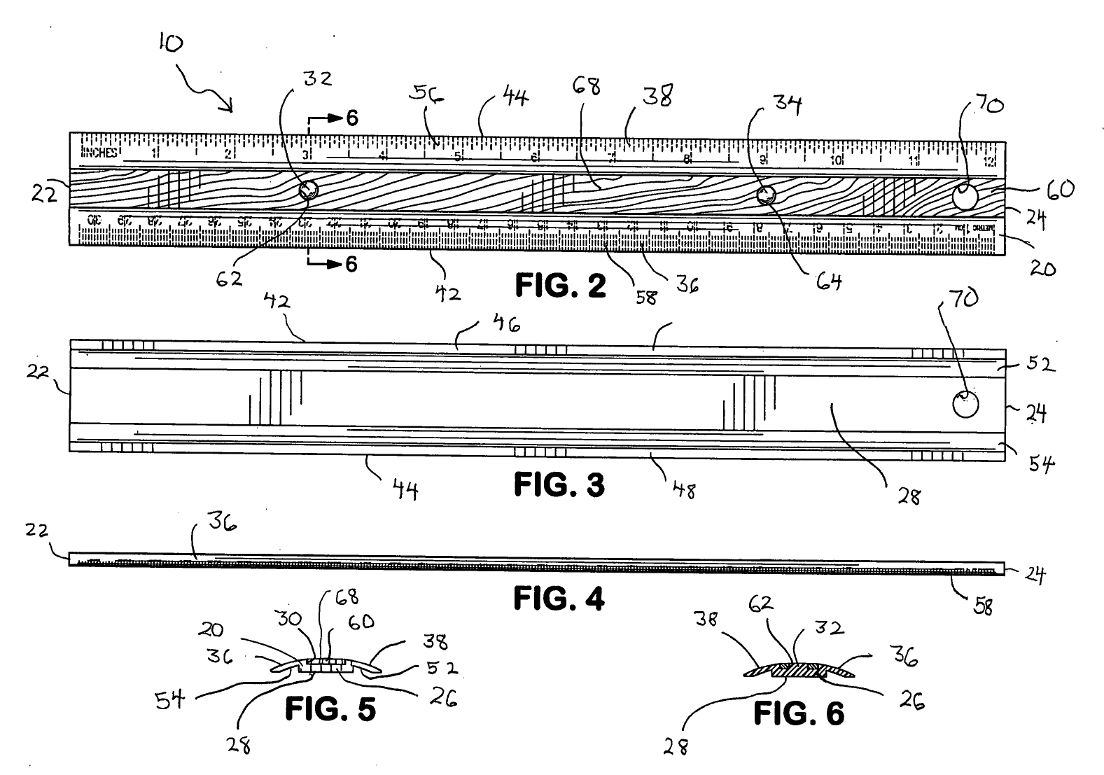

### DETAILED DESCRIPTION OF THE PREFERRED EMBODIMENTS

With reference to the drawings wherein like parts represent like elements throughout the Figures, a ruler with an inlay strip in accordance with the present invention is generally designated by the numeral 10. Ruler 10 is essentially a two piece construction which comprises a base 20 and an inlay strip 60. The ruler is adapted for use by schoolchildren and, as will be described below, presents a pleasing aesthetic appearance as well as a substantially rigid structure which is resistant to flexure and warpage.

The base 20 is preferably a molded member which longitudinally extends between ends 22 and 24, which, in a preferred embodiment, are approximately 12 inches apart. The central portion of the base has a central bed 26 which partially defines a longitudinally extending channel 30 of substantially uniform depth and width. The channel 30 extends between ends 22 and 24. A pair of bosses 32 and 34 which are substantially equidistantly spaced from the edges 22 and 24 integrally project upwardly from the channel bed 26. The upper surface of the base is further defined by substantially tapered or slightly convex, transversely spaced surface portions 36 and 38 which terminate at opposed edges 42 and 44.

With reference to FIG. 3, the underside of the base includes a central longitudinally extending planar support surface 28 which is preferably coplanar with underside edge portions 46 and 48. It will be appreciated that a pair of parallel recesses 52 and 54 extends longitudinally along the bottom surface thereof.

An English measurement scale 56 and a metric measurement scale 58 are preferably disposed longitudinally at the upper surface portions of the base and are designated by contrasting colors.

The inlay strip 60 preferably has a uniform width and diameter which is commensurate with the corresponding dimensions of the channel 30. The strip 60 includes a pair of longitudinally spaced openings 62 and 64 which are positioned to correspond with the positions of bosses 32 and 34 of the base. The dimensions of the openings 62 and 64 complement the diametral dimensions of the bosses 32 and 34. The inlay strip has a simulated wood grain upper surface 68. The inlay strip 60 is dimensioned so that it snugly fits in the channel 30 with the bosses 32, 34 being received in the respective openings 62,64 and extends from one end 22 to the other end 24 of the ruler. The inlay strip is preferably formed of plastic or other suitable material and is secured in place by a suitable adhesive.

In one form of the invention, a hang hole 70 is provided which extends through the inlay strip 60 and the base 20 to provide a convenient opening for hanging the ruler.

It should be appreciated that the foregoing inlay strip provides not only aesthetically pleasing appearance, but provides a reinforcement function for the ruler. The reinforcement function enhances the longitudinal rigidity of the ruler, mitigates against warpage, and makes the ruler more resistant to breakage under flexure when opposed forces are applied to opposing end portions of the ruler.

While a preferred embodiment of the invention has been set forth for describing the invention, the foregoing description should not be deemed a limitation of the invention. Accordingly, various modifications, alternatives and adaptations may occur to one skilled in the art without departing from the spirit and scope of the present invention.

What is claimed:

1. A ruler comprising:
an elongated base having an upper surface, a lower support platform, and a pair of transversely opposed edges and defining a longitudinally extending channel extending between opposed ends;
a pair of transversely spaced measuring scales each disposed adjacent a said edge on the upper surface; and
an elongated inlay strip disposed in said channel and extending substantially the longitudinal extent thereof.

2. The ruler of claim 1 further comprising a pair of bosses integrally projecting into said channel and said strip having a pair of openings receiving said bosses.

3. The ruler of claim 2 wherein said bosses are equidistantly spaced from opposing ends of said ruler.

4. The ruler of claim 1 wherein said inlay strip has an upper surface which simulates a wood grain.

5. The ruler of claim 1 further defining an opening adjacent an end location.

6. A ruler comprising:
an elongated base having an upper surface, a lower support platform, and a pair of transversely opposed edges and defining a central longitudinally extending channel extending between opposed ends;
a longitudinal measuring scale disposed adjacent a said edge on the upper surface; and
an elongated inlay strip disposed in said channel and extending substantially the longitudinal extent thereof and having an upper surface, which simulates wood grain.

7. The ruler of claim 6 further comprising a pair of bosses integrally projecting into said channel and said strip having a pair of openings receiving said bosses.

8. The ruler of claim 7 wherein said bosses are equidistantly spaced from opposing ends of said ruler.

9. The ruler of claim 6 further defining an opening adjacent an end location.

10. A ruler comprising:
an elongated base having an upper surface, a lower surface, a pair of transversely opposed edges and a pair of integral upwardly projecting bosses and defining a central longitudinally extending channel extending between opposed ends;
a pair of transversely spaced measuring scales each disposed adjacent a said edge on the upper surface; and
an elongated inlay strip disposed in said channel and extending substantially the longitudinal extent thereof and defining a pair of openings which receive said bosses.

11. The ruler of claim 10 wherein said bosses are equidistantly spaced from opposing ends of said ruler.

12. The ruler of claim 10 wherein said inlay strip has an upper surface which simulates wood grain.

13. The ruler of claim 10 further defining an opening adjacent an end location.

14. The ruler of claim 10 wherein said base includes a strip-like bed and said bed and inlay strip are disposed in adjacent parallel relationship.

15. The ruler of claim 10 wherein said base upper surface includes a pair of transversely spaced, longitudinal surfaces having a convex profile.
